(19) United States
(12) Patent Application Publication
(10) Pub. No.: US 2007/0264540 A1
(43) Pub. Date: Nov. 15, 2007

(54) CLAD METAL BIPOLAR PLATES

(75) Inventors: Kenneth Scott Weil, Richland, WA (US); Guanguang Xia, Pasco, WA (US); Jin Yong Kim, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 11/740,137

(22) Filed: Apr. 25, 2007

Related U.S. Application Data
(60) Provisional application No. 60/795,744, filed on Apr. 26, 2006.

(51) Int. Cl. H01M 8/00

(52) U.S. Cl. 429/12

(57) ABSTRACT

A clad metal bipolar plate and method for manufacture that can be cost efficiently produced and which provides excellent functional qualities. In one preferred embodiment of the invention the transition metal cladding is selected from a group of materials that form a self passivating layer when in use in a typical PEMFC operating environment. In another embodiment of the invention the transition metal cladding is selected from different types of transition metals and is treated with boron to form a transition metal boride that acts as a passivating layer when in use in a typical PEMFC operating environment. The use of transitional metal claddings over a metal core allows for various functional combinations and assists with cost effective manufacture of PEMFCs.

### PRIORITY

This invention claims priority from a provisional patent application 60/795,744 entitled Clad Metal PEMFC Bipolar Plate, filed Apr. 26, 2006. The contents of which are hereby incorporated by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

1. Field of the Invention

The invention generally relates to fuel cells and more specifically to components within Polymer Electrolyte Membrane Fuel Cells (PEMFCs).

2. Background Information

Fuel cells provide a highly efficient means of energy conversion, however, these devices currently find use only in niche applications. There are various reasons why these devices have not been more widely adapted. Among these reasons are the high cost of manufacture, the steady loss in power output during long-term continuous operation, and the current size and weight of most of the stacks that are utilized within these fuel cell devices.

One of the most bulky components in a typical fuel cell stack is the bipolar plate. In addition, it is one of the most expensive pieces to manufacture. However because this component serves a variety of functions within the device, including serving as the electrical junction between serially connected cells in the stack, distributing fuel and oxidant uniformly over the active areas of the cells, facilitating water management of the membrane, maintaining the hydrogen gradient across the membrane, providing structural support for the stack, and removing heat from the active areas of the cells, the modification of this part has proved to be difficult.

In PEMFCs, a variety of types of materials have been utilized in forming bipolar plates. However none of these embodiments have provided a material that suitably performed all of the aforementioned tasks and did so in a way that was cost efficient to manufacture and provided needed strength and rigidity to the device.

For example, graphite has been utilized. However, the high cost and low mechanical strength of high purity graphite as well as the additional expense associated with machining the individual plates necessitated the search for alternative bipolar plate materials with higher performance characteristics and lower costs. Various carbon-based composites have also been proposed however, these materials suffer from various deficiencies such as high manufacturing cost, insufficient mechanical strength, and poor barrier resistance to hydrogen permeability.

The use of metals has been investigated, but problems with corrosion and subsequent poisoning of the electrode catalysts with soluble corrosion products prohibit the long-term use of metals in most instances. In addition, formation of an oxyhydroxide layer on the surface of the metals tends to increase the contact resistance between the plate and a graphite electrode gas diffusion layer (GDL), often by many orders of magnitude. This phenomena both limits the amount of power that can be generated by the stack and serves as an additional source of heat that must be removed during operation. These factors are among the issues that have generally prevented the widespread use and implementation of this class of materials.

To overcome these issues, various attempts have been made to coat metallic plates with a protective layer that satisfies the functional requirements of the component. However, the existing methods of coating and the products that they produce also present various practical problems. These include: the incorporation of flaws during processing, chipping and scratching during subsequent manufacturing steps, poor adhesion between the coating and underlying substrate during stack assembly, and the additional manufacturing costs that are incurred and associated with the coating process. What is needed is a bipolar plate material that incorporates the advantages of metal, but undergoes little or no corrosion, is not susceptible to the manufacturing issues associated with coatings that have been listed previously, and which can be cost effectively manufactured.

### SUMMARY

The present invention is a clad metal bipolar plate that can be cost efficiently produced and which provides excellent functional qualities. The component is shaped or configured for use in PEMFC device, often by stamping or embossing operations. In one of the preferred embodiments of the invention, the plate is prepared with a transition metal cladding on the outer GDL-facing surface. Most preferably this transition metal is niobium (Nb) or another Group IVA-VIA transition metal. In another of the preferred embodiments of the invention the transition metal cladding comprises a non-noble d-transition metal, such as nickel (Ni) that is boronized after connection of the cladding with the underlying core. This covering and treatment of the outer surface forms a passivating surface when exposed to the low pH aqueous environment that is typical internally within each cell of the PEMFC stack. This structure of these devices and the methodologies taught in the present application enable the invention to be variously embodied and modified to meet the needs of the user and result in a useful, novel, non-obvious component that overcomes many of the problems found in prior art configurations.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. The preceding and following descriptions show and describe only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 is a detailed side view of a first preferred embodiment of the invention.

FIG. 2 is a perspective assembly view of an assembly of one embodiment of the clad metal bipolar plate shown in FIG. 1.

FIGS. 3a-3b are SEM micrograph images of the first preferred embodiment of the invention after predesignated testing.

FIG. 4 is a graph showing the interfacial contact resistance between niobium and carbon paper as a function of compaction pressure.

FIG. 5 is a graph showing behavior of niobium and platinum in 1M H₂SO₄+2 ppm HF at 80° C. under (a) simulated anode operating conditions of −0.1V and sparged hydrogen and (b) simulated cathode operating conditions of 0.6V and sparged air.

FIG. 6 is a graph showing the X-ray diffraction patterns for nickel coupons boronized by the powder-pack method.

FIG. 7 is a graph showing a summary of phase formation results as a function of powder-pack boronization temperature and time. The phases were identified by XRD analysis of the top surface of each boronized foil.

FIG. 8 is a graph showing boride layer thickness as a function of time at various boronization temperatures.

FIG. 9 shows cross-sectional SEM micrographs of nickel coupons in (a) the as-received state and after boronization at (b) 500° C. for 8 hrs, (c) 700° C. for 2 hrs, and (d) 700° C. for 8 hrs. Shown as insets in FIGS. 9(b)-(d) are high magnification images of the boride surface phase.

FIG. 10 shows cross-sectional SEM micrograph of the clad Ni/304SS/Ni material in (a) the as-received condition and (b) after boronization at 650° C. for 4 hrs. Local chemistry results measured by EDX at each point in the corresponding figures are given in Table 1.

### DETAILED DESCRIPTION OF THE INVENTION

The following description includes the preferred best modes of several embodiments of the present invention. It will be clear from this description of the invention that the invention is not limited to these illustrated embodiments but that the invention also includes a variety of modifications and embodiments thereto. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

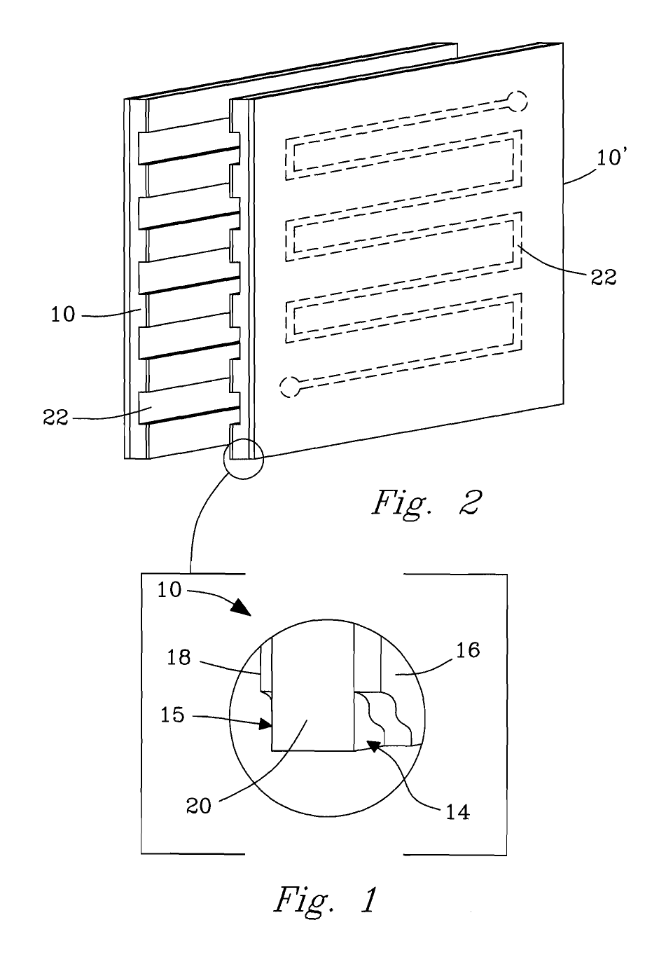

FIGS. 1-10 show a variety of features of the preferred embodiments of the present invention. While these preferred embodiments are shown and described, it is to be distinctly understood that the invention is not limited thereto but maybe variously embodied to meet the needs and necessities of a user.

Referring first to FIG. 1 a detailed side view of a preferred first embodiment of the invention is shown. In this preferred embodiment of the invention this invention is a bipolar plate 10 that has a first surface, which is preferably an outer surface 14 and a second surface 15. The size and dimensions of this plate 10 may be variously adapted to meet the needs and necessities of the users for the particular application in which the device is to be utilized. Most preferably this bipolar plate 10 is adapted and configured for placement within the fuel cell stack of a preselected PEM fuel cell. This bipolar plate 10 is preferably made from a metal laminate consisting of a core 20 and a transition metal cladding 16. The bipolar plate 10 is configured so that the transition metal cladding 16 is positioned on the outer surface 14 of the bipolar plate 10.

Preferably, the transition metal cladding 16 includes or is made up of at least one transition metal that is not a noble metal. In a first embodiment of the invention this transition metal cladding is Nb or other Group IVA-VIA transition metal Examples of materials that may be included and utilized in the transitional metal cladding in this preferred embodiment include: niobium, tantalum, molybdenum, tungsten, titanium, zirconium, vanadium, hafnium, tin, and alloys and combinations of these materials.

In another embodiment of the invention, such as will be described hereafter, the transition metal cladding 16 is made from a non-noble d-transition metal that has undergone full or partial boronization to form a transition metal boride. The method and rates at which the boronization take place are discussed hereafter.

In as much as a passivation layer is formed upon the transition metal cladding 16, the materials from which the core 20 is made can be selected based upon factors unrelated to their passivation characteristics. Thus materials such as plain carbon, stainless steel, alloyed steel, aluminum, aluminum alloys and combinations thereof may all be utilized in forming the core 20. While these designated material have been described it is to be distinctly understood that the invention is not limited thereto but may be variously configured according to the needs and necessities of the user.

In some embodiments of the invention, the bipolar plate 10 has a metal layer 18 attached to the second side 15 or the side opposite the outer surface 14. This metal layer 18 can be any of a variety of materials but is most preferably a braze or a solder filler material which is connected to this second side of the bi polar plate 10. Examples of these metal layer materials include copper, nickel, zinc, bismuth, and alloys thereof.

The acquisition of a transition metal boride upon the bipolar plate 10 may be accomplished in a variety of ways. In one embodiment of the invention the transition metal cladding 16 is coated with a boride product through a powder pack process. In other embodiments of the invention this boronization treatment may take place utilizing electroplating of the transition metal followed by heating. In other instances the boronization treatment may take place utilizing a boronizing gas to form an external boride layer. The exact specific details by which this boronization treatment may occur will vary according to the needs and necessities of the user, nevertheless the following description provides details related to the rates of transition metal boride formation sufficient to allow a party of skill in the art to produce transition metal boronization upon bipolar plates in accordance with their needs.

From this basic configuration a number of other combinations, variations and alternative embodiments are contemplated. For example, FIG. 2 shows an assembly view of a bipolar plate formed from two stamped laminated bipolar plates 10, 10′ that are joined via a brazing layer to form an internal water channel 22. While this particular configuration is shown, it is to be understood that the invention is not limited thereto but may be variously embodied to incorporate a variety of other combinations, modification and alternatives. This includes alternative embodiments wherein bipolar plates are formed with or without water channels from single or multiple laminated metal pieces that are clad on one or both exposed surfaces with a boronizable or nitridable layer or self-passivating transition metal layer.

In the preferred embodiment of the invention shown in FIGS. 1 and 2, the bipolar plate 10 is a piece of 430 stainless steel (430SS) which has been clad with commercial purity niobium (CP-Nb). This form of stainless steel (430SS) was selected because it is an inexpensive stainless steel that displays excellent formability. In the annealed condition CP-Nb also displays very good formability and ductility (˜80+% cold reduction in the annealed condition) and although it rapidly work hardens, it is readily roll bonded to 430SS under warm conditions.

In other embodiments of the invention other types of materials may also be utilized and selected so as to produce materials even more cost effectively. For example, the use of stainless steel in the core can be replaced with an even lower cost material such as 1080 steel. Ideally, the material selected for the core 20, which will form the thickest layer, is chosen based primarily on material cost, formability, durability, and thermal conductivity. The material used in the cladding layer 16 is then selected based on corrosion resistance, surface contact resistance, formability, and cost. In this way, the bipolar plate 10 can be tailored to take advantage of the merits of each material, while minimizing material and processing costs.

Fabrication of these plates 10 is preferably done by forming metal laminate sheets consisting of a metallic core roll bonded to a thin sheet of a transition metal alloy. This type of manufacture can be done commercially, with routine manufacture of various multilayer clad products in 50-5001 μm thick sheets. In a first preferred embodiment of the invention, the roll bonding process forms a metallurgical bond between niobium cladding and an underlying stainless steel core with no interfacial porosity present. Results from EDS characterization demonstrate only a minor amount of iron diffusion into the nodium cladding during warm rolling. Rather, the bondline between the two materials is quite distinct.

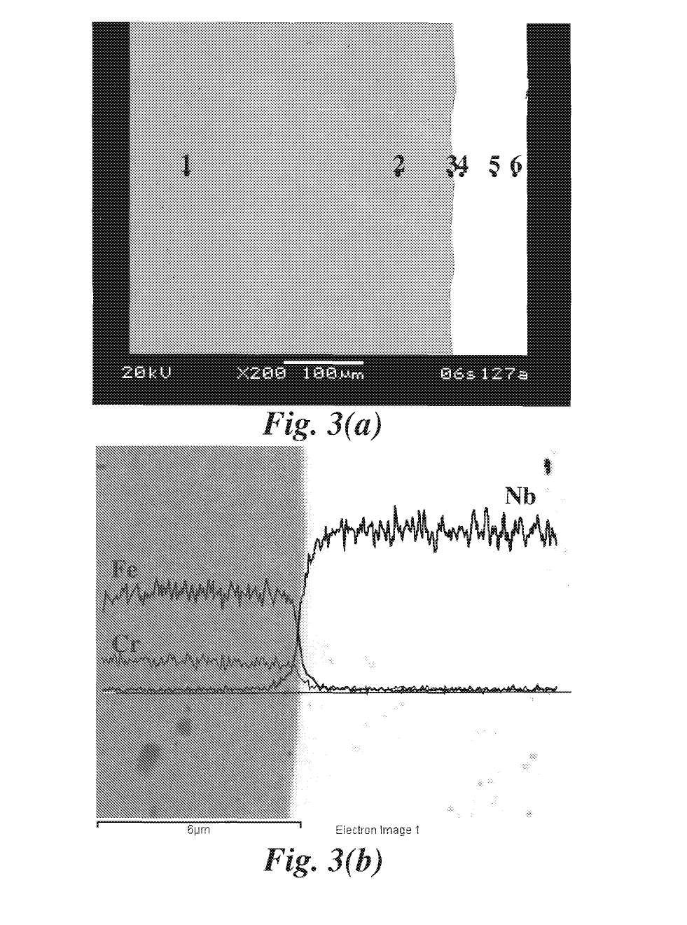

FIG. 3(a) shows a SEM scan of the preferred embodiment of the invention. Measurements of local chemistry at the points indicated in FIG. 3(a) are shown here below:

TABLE 1
EDX Results for Points Marked in FIG. 3(a)

Composition, at %

| Point | Fe | Cr | Si | Nb |
|---|---|---|---|---|
| 1 | 81.66 | 17.57 | 0.77 | — |
| 2 | 83.11 | 16.10 | 0.79 | — |
| 3 | 62.07 | 13.27 | 0.79 | 23.87 |
| 4 | 14.46 | 3.90 | — | 81.64 |
| 5 | 1.50 | — | — | 98.50 |
| 6 | 0.89 | — | — | 99.11 |

These measurements indicate that diffusion is limited to a ˜5 μm thick region on either side of the bondline. An elemental line scan of iron, niobium, and chromium across the core/clad interface shown in FIG. 3(b) confirms this result. This limited iron diffusion of the niobium cladding during warm rolling reduces the number of brittle intermettalic phases which would then potentially limit the amount of forming that can take place in the laminate sheet during subsequent stamping operations.

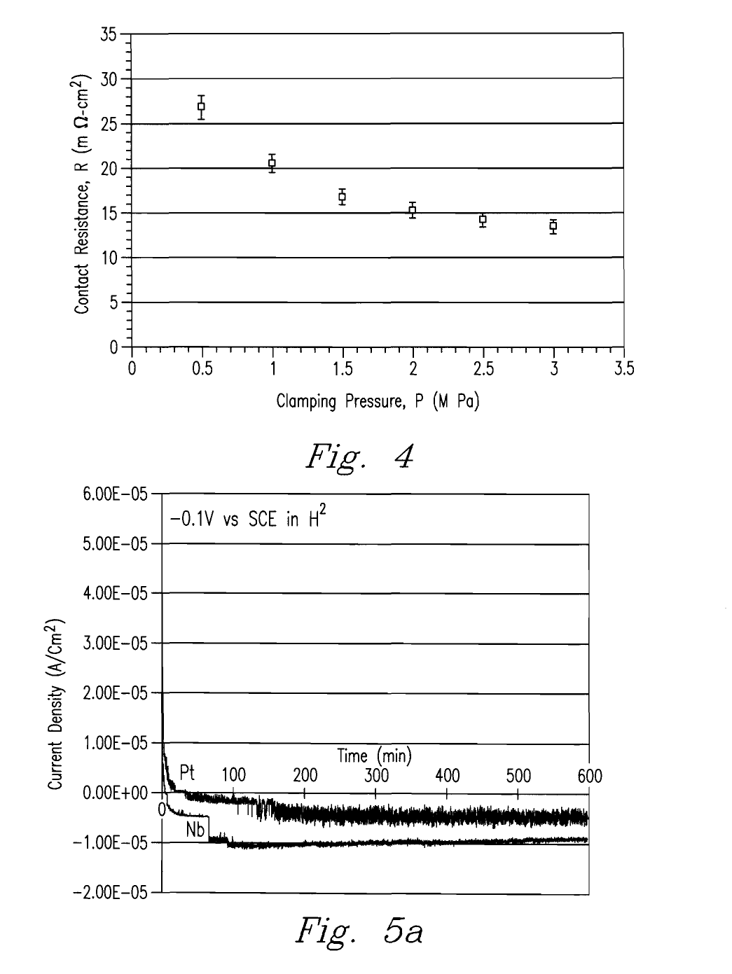

Displayed in FIG. 4 are the results of area specific interfacial contact resistance measurements for the niobium clad material as a function of compaction pressure. As with monolithic niobium, the amount of compression required to achieve a low level of contact resistance is quite small and the magnitude of resistance is again quite comparable to that observed in surface treated and graphitic bipolar plate materials.

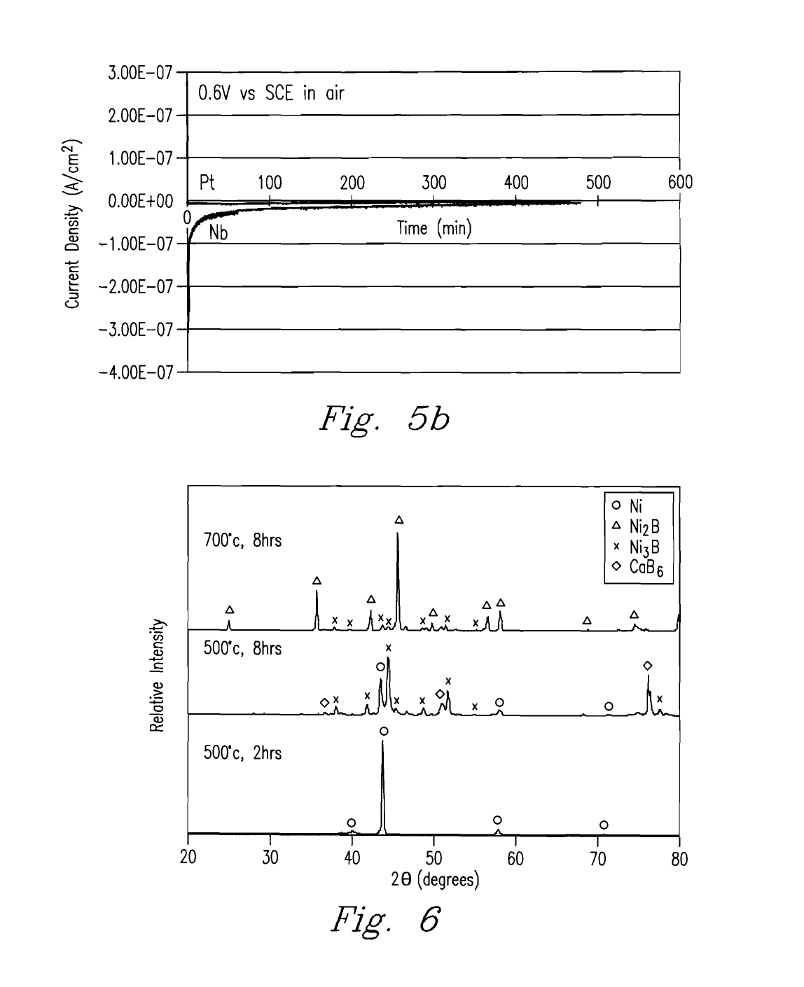

FIG. 5 is a chart showing the anodic polarization curves for niobium clad 430SS material in PEFMC operation conditions (1M H₂SO₄+2 ppm HF at 80° C.). The curve shown in FIG. 5 is generally quite similar to those recorded for platinum, indicating that the niobium cladding layer behaves similarly to the noble metals under simulated PEMFC operating conditions and effectively passivates and protects the underlying stainless steel from corrosion. In some embodiments of the invention, the treatment of the metal cladding layer by a boronization process, particularly as a final step of the manufacturing process, provides additional desired capabilities to the material.

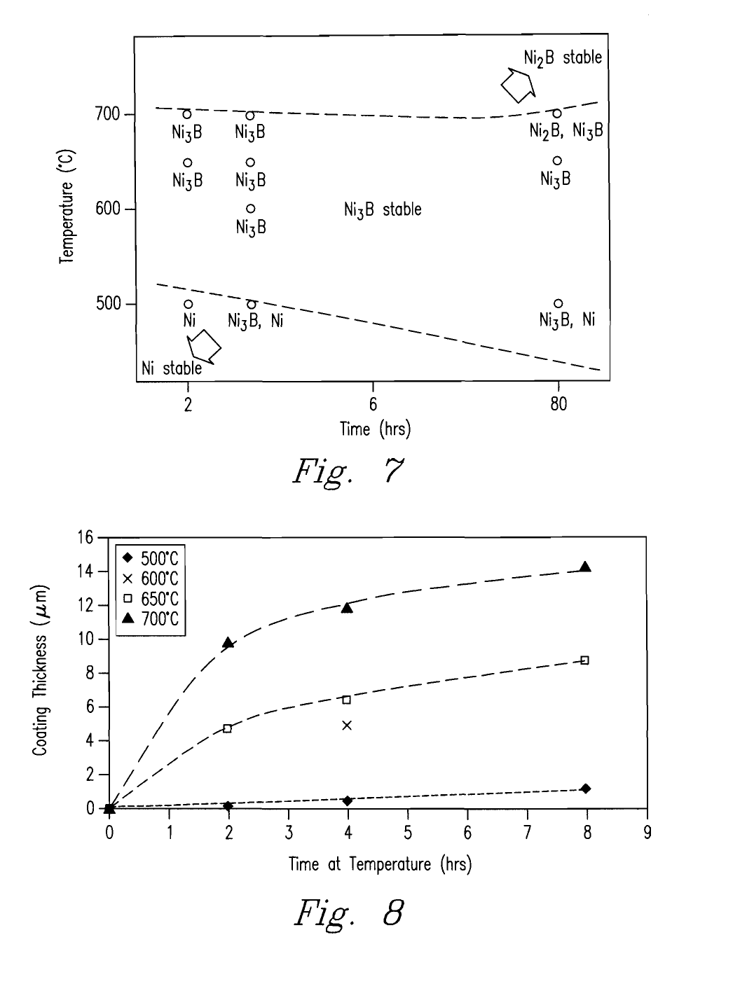

In another preferred embodiment of the invention, a transition metal cladding (nickel) was treated through a boronization process (described below). Results from energy dispersive X-ray analysis, X-ray diffraction, and scanning electron microscopy, shown in FIGS. 6-7 indicate that under moderate boronization conditions a homogeneous Ni₃B layer grows on the exposed surfaces of a transition metal such as nickel, the thickness of which depends on the time and temperature of boronization according to a Wagner-type scale growth relationship. At higher temperatures and longer reaction times, a Ni₂B overlayer forms on top of the Ni₃B during boronization.

In the testing that was performed a nickel clad laminate underwent a powder packed boronization process under the following conditions. The nickel clad laminate [fabricated by Engineered Materials Solutions Inc. EMS; Waltham, MA; 114.6 μm (4.5 mil) thick 304 stainless steel core clad with 12.7 μm (0.5 mil) thick Ni] was prepared for boronization by being cut into 25 cm×25 cm coupons that were lightly polished on both surfaces with coarse nickel wool, cleaned in an ultrasonic bath, and dried at room temperature in the same manner. The nominal composition of 304SS is 17.5-20% Cr, 8-11% Ni, <2% Mn, <1% Si, <0.08% C, balance Fe. A powder-pack boronization then took place utilizing a mixture of 98.6% CaB₆ (99.9% purity; Alfa Aesar) and 1.4% KBF₄ (99% purity; Alfa Aesar) by weight. These two powders were ground together and poured into a graphite crucible. For each boronization run, a single coupon was buried into a freshly prepared powder bed and heated in ultra high purity helium at 20° C./min to temperature, held for a predetermined period of time between 2 and 8 hrs, and cooled at 10° C./min to room temperature.

After heat treatment, the surfaces of these samples were analyzed by XRD to identify the boronization product phase(s). The analysis was carried out in a Philips Wide-Range Vertical Goniometer and XRG3100 X-ray Generator over a scan range of 20-80° 2θ, with a 0.04° step size and 2s hold time. XRD pattern analysis was conducted using Jade 6+ (EasyQuant) software. SEM and EDX analysis were conducted to determine the microstructure and thickness of the boride coating using a JEOL JSM-5900LV equipped with an Oxford Energy Dispersive X-ray Spectrometer (EDS) system.

As is shown in the sequence of diffractograms shown in FIGS. 6-7 Ni₃B forms as the primary surface product on the boronized nickel foils at low-to-moderate temperatures and/or short reaction times. Under more aggressive boronization temperatures, Ni₂B appears as a significant surface phase. At the mildest boronization condition considered in this study, 500° C./2hrs, only nickel peaks were observed in the corresponding XRD pattern. However comparison of the positions of these peaks with the standard pattern reported in the ICDD database indicates that the cubic lattice parameter is expanded by ˜4.3%, likely due to diffusion and alloying of boron into the exposed nickel surface. The complete results from XRD analysis are summarized in FIG. 8 as a function of boronization temperature and time.

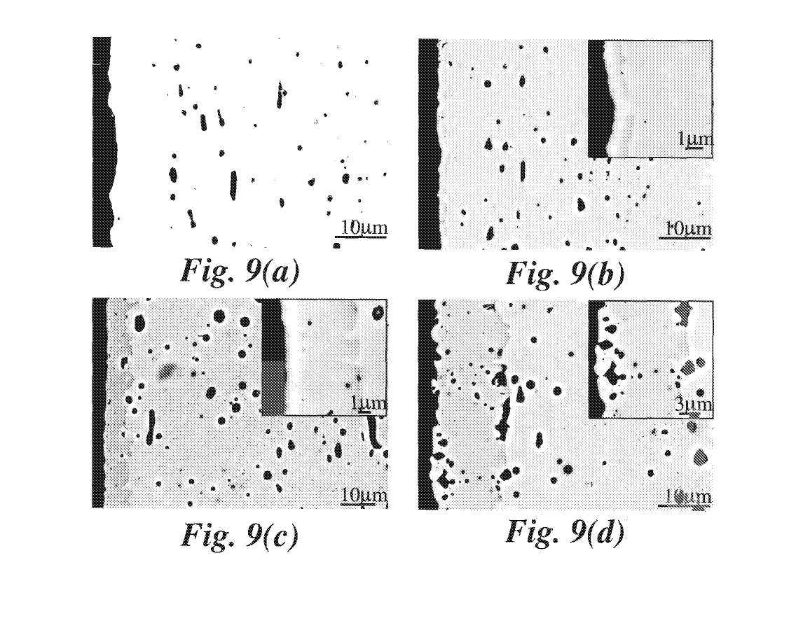

The micrographs shown in FIGS. 9(a)-(d) display the microstructures of the nickel foil in the as-received and boronized conditions. Shown as inserts in FIGS. 9(b)-(d) are higher magnification images of the boride phase near the exposed surface of each respective foil. As seen in FIG. 9(a), the as-received foil exhibits an unexpected lamellar structure, with a sub-dense core that contains micron-sized closed pores sandwiched on either side by a ˜10 μm thick dense outer layer. Shown in FIG. 9(b) is a foil sample that was boronized at 500° C. for 8 hrs. Correlation with the XRD data suggests that the uniform ˜1.5 μm thick reaction layer observed along the outer edge of the coupon is Ni₃B. Under more aggressive boronization conditions, this reaction zone becomes more extensive but remains quite uniform in thickness, as seen in FIGS. 9(c) and (d) for coupons heat treated at 700° C. for 2 and 8 hrs respectively. The key differences between these two microstructures are the presence of a thin Ni₂B overlayer and porosity in the underlying reaction zone of the coupon boronized for 8 hrs, which are likely related to each other via a Kirkendall effect between the various phases.

The Ni₃B surface phase found in the 500° C. specimen [inset of FIG. 9(b)] exhibits a columnar grain morphology, with an average width of ˜0.5 μm. At higher boronization temperatures the grains remain columnar and elongate substantially toward the centerline of the foil, as seen in the inset of FIG. 9(c). The width of these grains is 1.5 μm and they average 10 [symbol] m in length. With longer time at 700° C. [see the inset of FIG. 9(d)] a Ni₂B overlayer begins to form on top of the Ni₃B layer. Under these particular reaction conditions, the overlayer measures approximately 0.5-1 μm thick and is supported on a 10 μm thick layer of Ni₃B.

Based on measurements taken during SEM analysis, the depth of the boride formation is plotted as a function of boronization time and temperature in FIG. 8. At each temperature, the thickness of the reaction zone is found to increase with time in a nearly parabolic manner. This trend indicates that initial boride formation is uniform and that it tends to act as a physical barrier, slowing further boronization. The growth behavior is similar to that observed in the oxidation of alloys that form a protective oxide scale.

A simple one dimensional Wagner-type expression can be used to describe the kinetics of boride growth:
x²=kₚt (1)
where x is the thickness of the boride layer, kₚ is the parabolic boronization rate constant, and t is the time of boronization. Fitting the data in FIG. 4 to Equation (1), the parabolic rate constants for boride layer growth in nickel are approximately 9.99×10⁻³ μm²/s at 700° C., 2.85×10⁻³ μm²/s at 650° C., and 2.18×10⁻⁵ μm²/s at 500° C.

Shown in FIGS. 5(a) and (b) are cross-sectional micrographs of the clad material in the as-received and boronized conditions. The foil in FIG. 5(b) was boronized at 650° C. for 4 hrs. XRD analysis indicates that only Ni3B forms on the surface of the specimen. Measurements of the boride layer thickness taken during SEM analysis indicate that the reaction zone is ˜7 μm thick on average, similar that observed in pure nickel coupons under the same processing conditions. However as is readily apparent in the micrograph, the thickness of the reaction layer is non-uniform across the sample. That is, the boride layer does not grow homogeneously across the surface of the nickel cladding layer.

The local chemistry of the as-received and boronized laminate foils was measured via EDX (on a metal-only basis due to the error band associated with boron measurements) at the points indicated in the two micrographs and the results are presented in Table 2 below.

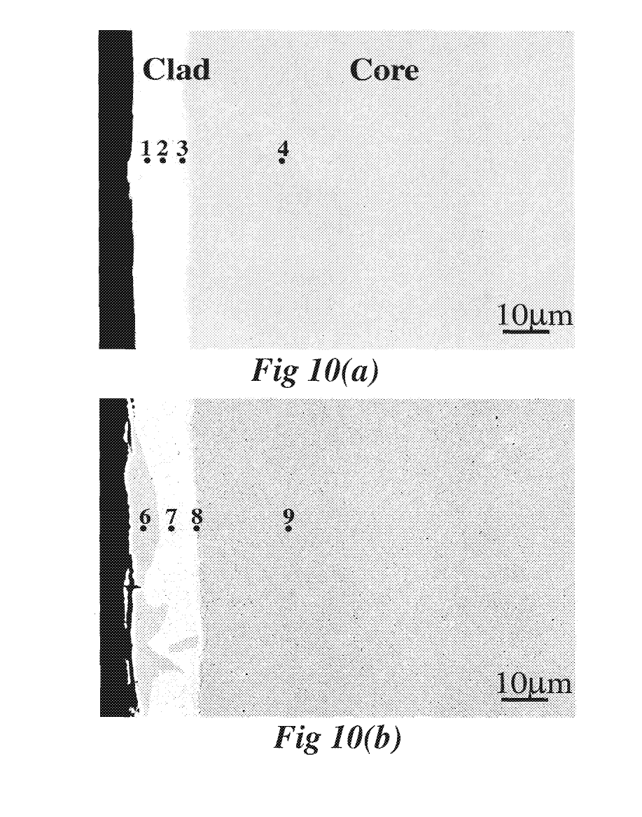

TABLE 2
EDX Results for Points Marked in FIGS. 10(a)-(c)

| | Composition, at % | | | | |
|---|---|---|---|---|---|
| Point | Fe | Ni | Cr | Mn | Si |
| 1 | — | 100.0 | — | — | — |
| 2 | 1.06 | 98.94 | — | — | — |
| 3 | 2.25 | 97.75 | — | — | — |
| 4 | 69.35 | 8.44 | 19.21 | 1.81 | 1.19 |
| 5 | — | 100.0 | — | — | — |
| 6 | 1.05 | 98.95 | — | — | — |
| 7 | 7.63 | 89.54 | 1.99 | 0.84 | — |
| 8 | 69.16 | 8.97 | 18.90 | 1.62 | 1.35 |

In the as-received foil, the top several microns of the nickel cladding remain undisturbed with respect to diffusion from the underlying stainless steel core layer. Approximately five microns into the cladding layer, a small amount of iron is observed in the nickel and the content of iron appears to gradually increase as a function of depth into the cladding up to the clad/core bondline. As expected, the additional heat treatment that the boronized foil undergoes leads to further diffusion of iron, as well as chromium and manganese, into the cladding layer. Note however that the boride reaction zone appears to be composed solely of nickel boride (Ni₃B). No other metal species were observed in this layer. In the present case, the effect is plainly visible in non-uniform thickness of the reaction zone.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A bipolar plate adapted for use in a PEM fuel cell comprising:
a plate body having an outer surface, said outer surface having a transition metal cladding layer connected thereto.

2. The bipolar plate of claim 1 wherein the transition metal within the transition metal cladding layer is not a noble metal.

3. The bipolar plate of claim 2 wherein said transition metal cladding layer has been at least partially converted to a transition metal boride.

4. The bipolar plate of claim 3 wherein said transition metal cladding layer has been fully converted to a transition metal boride.

5. The bipolar plate of claim 1 further comprising a metal layer connected to said plate body opposite said outer surface.

6. The bipolar plate of claim 5 wherein said metal layer comprises a material selected from the group consisting of copper, nickel, tin, zinc, bismuth and alloys thereof.

7. The bipolar plate of claim 1 wherein said plate body is a metal laminate, said metal laminate comprised of a core.

8. The bipolar plate of claim 7 wherein said core is a material selected from the group consisting of plain carbon, stainless steel, alloyed steel, aluminum, aluminum alloys and combinations thereof.

9. The bipolar plate of claim 1 wherein said transition metal within said transition metal cladding is a material selected from the group consisting of niobium, tantalum, molybdenum, tungsten, titanium, zirconium, vanadium, hafnium, tin and alloys thereof.

10. The bipolar plate of claim 1 wherein said transition metal is selected from the group consisting of nickel, iron, manganese, chromium, cobalt, and alloys thereof.

11. The bipolar plate of claim 10 wherein said transition metal is coated with a boride product.

12. The bipolar plate of claim 10 wherein said transition metal has been partially converted to a boride product.

13. The bipolar plate of claim 10 wherein said transition metal has been fully converted to a boride product.

14. The bipolar plate of claim 10 wherein said transition metal cladding layer comprises a metal selected of the group consisting of Group IVA-VIA transition metals and alloys thereof.

15. The bipolar plate of claim 1 wherein said transition metal cladding layer comprises a non-noble d-transition metal.

16. The bipolar plate of claim 15 wherein said transition metal cladding layer has been at least partially boronized.

17. The bipolar plate of claim 15 wherein said transition metal cladding layer has been at least partially nitrided.

18. The bipolar plate of claim 9 wherein said transition metal cladding layer is self passivating.

19. A method for forming a bipolar plate for use in a PEM fuel cell said method comprising the step of:
forming an external boride layer upon a piece of metal laminate, said piece of metal laminate having a preselected size and shape and a non-noble d-transition metal outer layer.

20. The method of claim 19 wherein said step of forming an external boride layer includes the step of powder packing.

21. The method of claim 20 wherein said step of forming an external boride layer includes the steps of electroplating and heating.

22. The method of claim 21 wherein said step of forming includes reactive conversion of the transition metal outer layer using a boronizing gas to form the external boride layer.
